(19) United States
(12) Patent Application Publication
(10) Pub. No.: US 2017/0038761 A1
(43) Pub. Date: Feb. 9, 2017

(54) INFORMATION ACQUISITION DEVICE OF MACHINE TOOL

(71) Applicant: Okuma Corporation, Niwa-Gun (JP)

(72) Inventors: Tomoharu ANDO, Niwa-Gun (JP); Takaaki TANAKA, Niwa-Gun (JP)

(73) Assignee: Okuma Corporation, Niwa-Gun (JP)

(21) Appl. No.: 15/189,140

(22) Filed: Jun. 22, 2016

(30) Foreign Application Priority Data
Aug. 3, 2015 (JP) 2015-153521

(51) Int. Cl. G05B 19/406

(52) U.S. Cl. CPC G05B 19/406; G05B 2219/31336; G05B 2219/40361

(57) ABSTRACT

An information acquisition device for machine tool includes a time series information recording unit, an event information recording unit, and an output unit. The time series information recording unit is configured to acquire machine information in time series at a predetermined timing. The event information recording unit is configured to record at least one of: a change content and time at which any one of step information related to a process step, tool information, control panel information related to a control panel of the machine tool, workpiece information, and operator information is changed; and an instruction and time at which the instruction related to a start or an end of machine control execution is issued. The output unit is configured to output time-series data of the machine information recorded in the time series information recording unit together with event data recorded in the event information recording unit.

### BACKGROUND

This application claims the benefit of Japanese Patent Application Number 2015-153521 filed on Aug. 3, 2015 the entirety of which is incorporated by reference.

### TECHNICAL FIELD

The disclosure relates to an information acquisition device for acquiring and recording machine information in a machine tool that performs processing while a tool or workpiece rotates.

### RELATED ART

In a machine tool that rotates a tool or workpiece mounted to a rotation shaft and moves the tool and the workpiece relatively to perform processing, a damage of the tool causes a processing failure where the workpiece cannot be processed in desired dimensions and shape. Additionally, if an axis feeding continues to be operated in a condition where the workpiece cannot be removed because of the damage of the tool, the tool is likely to collide with the workpiece, damaging the machine as well as the tool and the workpiece. To prevent the damages, there is a typical method where a load on a main spindle motor, which is considered to best represent the state of the processing, is monitored to stop feed axes or a similar method. There has been known the following method for monitoring a main spindle load. In the method, when actually a processing can be normally performed, the main spindle load is recorded for a certain period of time to create a reference waveform, and the main spindle load is compared with the reference value at regular time intervals. FIG. 1 illustrates a diagram for illustrating a load during actual normal processing that is recorded as a reference value, and threshold values for alarming that are offset from the reference value in the vertical direction. Allowing such threshold setting, an appropriate margin can be set in the case of large variation in load, for example, a drilling process. Meanwhile, when the main spindle load is monitored using the reference value, it is necessary to preliminary record the reference value in a normal process at timing of processing to be monitored.

There has been known Japanese Patent No. 3333637 (hereinafter referred to as Patent Document 1) as a technique of automatically acquiring the reference value (the maximum value of load). Patent Document 1 discloses the following upper limit value setting device for process load. The upper limit value setting device stores a monitoring interval specification file, which is configured of a plurality of records including an tool ID and an upper limit value of a load, and stores the maximum value of load detected during processing together with the tool ID. When the tool ID and a motor ID are input while an input screen for the monitoring interval specification file is displayed, the upper limit value setting device reads the maximum value of a load detection value of the motor during use of the tool from the stored data and displays the maximum value on a monitor.

Machine information such as load that a machine tool has can be used for process analysis. As a technique of measuring a load whenever a cutting operation is performed, there has been known JP-A-2011-118840 (hereinafter referred to as Patent Document 2). Patent Document 2 discloses the following numeral value control unit. When a cutting operation is instructed, the numeral value control unit decides a servo motor for a feed axis to start moving the feed axis. The numeral value control unit measures a load torque of each motor and records the measured data of the load torque in a recording memory.

In addition to the above-described process monitoring and machine diagnostics, machine information on the machine tool may be effective to the machine diagnostics by, for example, comparison of secular change during a machine operation in non-cutting. As a technique that determines whether a machine tool is in a cutting operation or not to monitor a load, there has been known Japanese Patent No. 4087374 (hereinafter referred to as Patent Document 3). In Patent Document 3, a sequence number of a block whose load torque is not monitored is input. When an instruction of a block in execution is determined as a positioning instruction and does not match the stored sequence number, a load torque on a feed motor during a positioning operation is monitored. Accordingly, an operation during cutting or a similar operation is identified and abrasion or a similar defect in a movable portion (a feed axis) of a machine is monitored.

In process monitoring using a load, even if the processing is normally performed, the load possibly may vary in practice due to a manufacturing variation of a material and a material shape of workpiece and a tool and insufficient flow rate of a cutting fluid. In addition to these, due to a change in an amount of cutting caused by a program modification and a change in an axis speed caused by an incorrect operation of an override switch, the load possibly changes and exceeds a threshold value. Therefore, in case of the excess of the threshold value, it is necessary to record these pieces of information and analyze a cause of the excess of the threshold value. However, the technique disclosed in Patent Document 1 allows predetermining the tool ID and the motor ID as monitored targets and only recording these pieces of information and the load, and therefore, the technique cannot analyze the cause in detail. Analysis only with time-series data near the time at which the load exceeds the threshold value may be insufficient. In this case, it is necessary to perform the analysis going back to processing by a tool other than a monitoring target (a rough process step or a similar step).

Furthermore, it is also necessary to collate time-series data, where processes are divided, with normal processing. In the case where a tool shaft inverts like a drilling cycle, in the technique disclosed in Patent Document 2, data is divided at an inverting position and is recorded. However, for example, also in the case where the tool shaft moves like an arc motion while cutting is performed in the identical direction, data may be desired to be divided.

Meanwhile, in practice, reference data needs to be acquired through a statistic process. To acquire the reference data, it is necessary to perform a process on a desktop PC or a similar device in the light of complicated setting, rather than on a controller. Accordingly, it is suitable that the required information is appropriately recorded and the process is performed later.

In the machine diagnostics, in order for comparison of secular change of the acquired machine information, it is also necessary to extract data when an identical operation is performed. Therefore, a position, a speed, an equipped workpiece weight, and a tool weight need to be identified. In the technique disclosed in Patent Document 3, the load torque is measured in an interval specified by the sequence number of a process program. However, collection of data from many machines causes an interval without program instruction, and it is necessary to acquire data to search for a failure cause that has occurred suddenly. Accordingly, the technique disclosed in Patent Document 3, in which the load torque is monitored in the program, possibly fails to record.

Therefore, an object of the disclosure is to provide an information acquisition device of a machine tool that can preferably acquire machine information required for detailed process diagnostics and machine diagnostics.

### SUMMARY

In order to achieve the above-described object, there is provided an information acquisition device for a machine tool according to a first aspect of the disclosure. The information acquisition device for the machine tool acquires information on a machine tool. The information acquisition device for the machine tool includes a time series information recording unit, an event information recording unit, and an output unit. The time series information recording unit is configured to acquire machine information in time series at a predetermined timing. The event information recording unit is configured to record at least one of: a change content and time at which any one of step information related to a process step, tool information, control panel information related to a control panel of the machine tool, workpiece information, and operator information is changed; and an instruction and time at which the instruction related to a start or an end of machine control execution is issued. The output unit is configured to output time-series data of the machine information recorded in the time series information recording unit together with event data recorded in the event information recording unit.

In the information acquisition device for the machine tool according to a second aspect of the disclosure, which is in the first aspect of the disclosure, the output unit includes a machine information clipping unit. The machine information clipping unit is configured to make the time-series data recorded in the time series information recording unit correspond to the time recorded in the event information recording unit to extract the time-series data.

In the information acquisition device for the machine tool according to a third aspect of the disclosure, which is in the second aspect of the disclosure, the output unit includes a monitor. The monitor is configured to display a change aspect of the time-series data extracted by the machine information clipping unit and the event data corresponding to the time.

In the information acquisition device for the machine tool according to a fourth aspect of the disclosure, which is in the third aspect of the disclosure, a priority order of the event data is preset to the event information recording unit. The output unit is configured to display only the event data at the high priority order on the monitor when display items of the event data exceed the preset count.

In the information acquisition device for the machine tool according to a fifth aspect of the disclosure, which is in any of the first to fourth aspects of the disclosure, the machine information is at least any one of a load of a rotation shaft, a load of a feed axis, a position of the feed axis, a vibration during processing, a flow rate of a cutting fluid, and a counter value of a program-executing block.

In the information acquisition device for the machine tool according to a sixth aspect of the disclosure, which is in any of the first to fifth aspects of the disclosure, the step information is at least one of a processing step for an interactive system program, a program name, and a sequence number. The tool information is at least one of a tool number, a tool length correction value, and a tool diameter correction value. The control panel information is a value of an override switch. The workpiece information is a workpiece origin or a serial number of the workpiece.

In the information acquisition device for the machine tool according to a seventh aspect of the disclosure, which is in any of the first to sixth aspects of the disclosure, the machine control is at least one of a start and an end of program execution, a start and an end of process monitoring execution, a start and an end of an axis operation for machine diagnostics, a start and an end of a fixed cycle operation, and a start and an end of a discharge of a cutting fluid.

The information acquisition device for the machine tool according to the first aspect of the disclosure separately acquires the respective time-series data and the event data of the machine information. Therefore, it is ensured to acquire the time-series data of the load or similar information, which allows finding, for example, a time until when the program, the tool, a switch operation of a control panel, the workpiece, and operator information have not changed and a time until when a machine control has been performed. Accordingly, the time-series data with a clear period for handling as a sequence of processes is acquired over a long period. In view of this, the machine information required for detailed process diagnostics and machine diagnostics can be preferably acquired.

With the information acquisition device for the machine tool according to the second aspect of the disclosure, in addition to the above-described effects, the use of the machine information clipping unit allows clipping specific time-series data from the recorded machine information. Accordingly, for example, reference data for process monitoring and large-capacity data recorded at high sampling cycles for detailed analysis are clipped to decrease the capacity, thereby allowing ease of handling. Consequently, clipping a required interval for analysis is possible, and therefore, analysis efficiency improves. Accordingly, all-time recording of a time series waveform is ensured, which enables recording a processing failure in unanticipated tool and operation, thus ensuring the analysis of the processing failure.

With the information acquisition device for the machine tool according to the third aspect of the disclosure, in addition to the above-described effects, the change aspect of the machine information in time-series is displayed together with the event data. Therefore, for example, when the clipped time-series data of the main spindle load during program execution is displayed, the entire processing can be reviewed from a higher perspective, which leads to the process diagnostics.

With the information acquisition device for the machine tool according to the fourth aspect of the disclosure, in addition to the above-described effects, when a period of displayed time-series data is long and therefore the events are many, especially important events are preferentially displayed so that the time-series data can be easily reviewed from a higher perspective.

With the information acquisition device for the machine tool according to the fifth aspect of the disclosure, in addition to the above-described effects, by recording the time-series data of the load of the axis and the processing vibration, the process state and the machine state can be determined. Although the program name is identical, if the program is changed and the path is changed, whether or not the paths are identical can be confirmed by the recording of the time-series data of the feed axis. Through the recording of the time-series data of the flow rate of the cutting fluid, a failure in a cutting fluid pump and a clogging of a filter can be determined. Furthermore, through the recording of time-series data of a counter value of a program-executing block, a program line in execution can be found.

With the information acquisition device for the machine tool according to the sixth aspect of the disclosure, in addition to the above-described effects, by recording the process step for the interactive system program, a process step for a program created by interactive system programming can be identified. Additionally, as program information, the program name and the sequence number can be recorded. For example, by adding version information to the program name, the used program can be identified. Further, with the sequence number, the execution block can be identified. Through recording of the tool number, the tool length correction value, and the tool diameter correction value as the tool information, a tool state can be grasped using a correction value corrected due to tool abrasion. As the workpiece information, the workpiece origin and the serial number of the workpiece can be recorded, thus allowing grasping the axis position on a workpiece coordinate system from the origin of the workpiece and the axis position in time series, which is the recorded machine information. The dimensions and measurement value of roughness of the workpiece can be linked to the main spindle load in time series or similar information, which is the machine information, using the serial number.

With the information acquisition device for the machine tool according to the seventh aspect of the disclosure, in addition to the above-described effects, the start and end of program execution and the program name can be recorded, thereby determining a program name actually executed and the execution time. When the period of the start and end of the process monitoring execution can be recorded, for example, a reference waveform is created with the main spindle load during normal processing, and the main spindle load is compared with the reference value at regular time intervals for process monitoring, the time-series data of the main spindle load in the process monitoring interval can be compared with the reference value. The data recorded during the operation of the machine diagnostics and the discharge of the cutting fluid is used to check the normality in such a manner that the maximum value of the time-series data of the feed axis load during the operation of the machine diagnostics is compared with the threshold value, and the time-series data of the flow rate of the cutting fluid during the discharge of the cutting fluid is compared with the threshold value. The data recorded during the fixed cycle operation is used to determine whether or not a motion as assumed has been performed by checking the time-series data of the position of the axis recorded as the machine information.

### BRIEF DESCRIPTION OF THE DRAWINGS

FIG. 1 is an explanatory view illustrating a setting example of threshold values that are offset from a reference waveform.

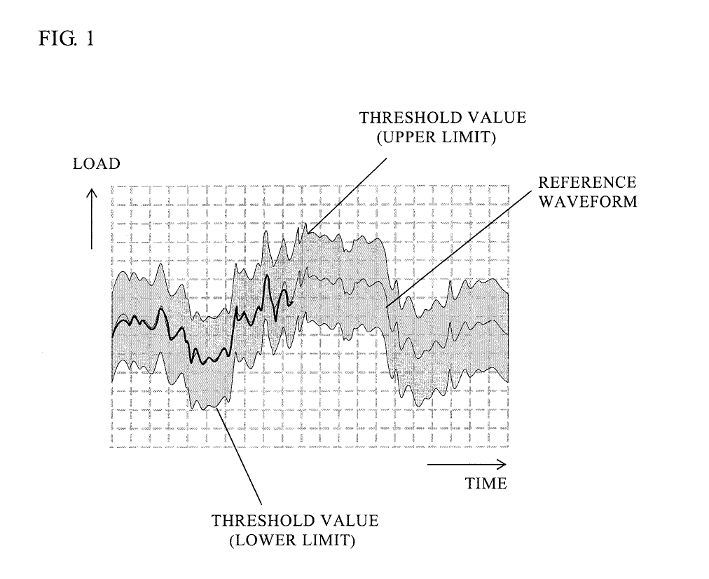

FIG. 2 is a block configuration diagram illustrating a machine tool.

FIGS. 3A and 3B are information examples of recorded machine tool, FIG. 3A shows time-series data at each any given time, and FIG. 3B shows event data.

FIG. 4 is an explanatory view of a waveform display window displayed on a monitor.

### DETAILED DESCRIPTION

The following describes an embodiment according to the disclosure based on the drawings.

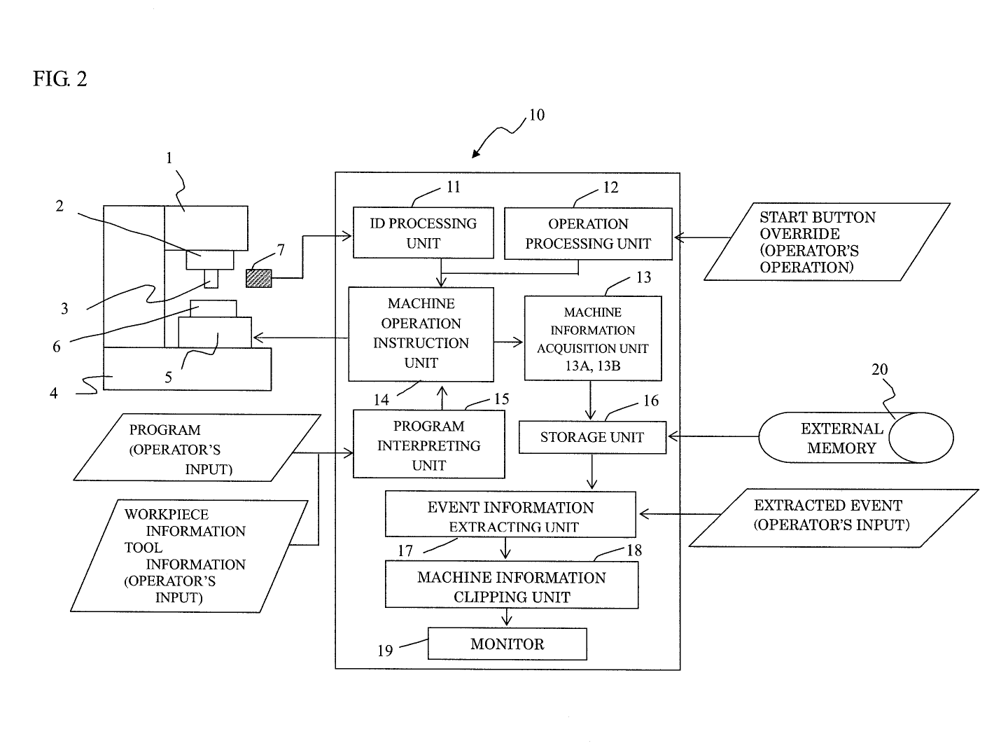

FIG. 2 is a block configuration diagram illustrating an exemplary machine tool. The machine tool includes a main spindle housing 1 that includes a main spindle 2 as a rotation shaft. The main spindle 2 is configured to be rotated by a main spindle motor. On a distal end of the main spindle 2, a tool 3 such as a drill and an end mill is mounted. The machine tool includes a table 5 on which workpiece 6 is secured on a bed 4. A feed axis mechanism relatively moves the tool 3 and the table 5 in X-axis, Y-axis, and Z-axis directions, which are orthogonal to one another, to process the workpiece 6.

An NC system 10 controls the machine tool. The NC system 10 operates a machine based on a program to process the workpiece 6 and also functions as an information acquisition device of the disclosure.

An operator inputs a program, workpiece information, and tool information to the NC system 10. A program interpreting unit 15 performs an execution process to interpret the program, the workpiece information, and the tool information as a main spindle rotation instruction, a feed axis operation instruction, and a tool exchange instruction, and transmits the respective instructions to a machine operation instruction unit 14. The machine operation instruction unit 14 controls the main spindle 2, the feed axis mechanism, a tool changer (not illustrated), or a similar device based on the respective instructions. To check the tool 3 mounted to the main spindle 2, the machine tool includes a reader 7. The reader 7 reads a tool ID in an IC chip embedded into the tool 3. The tool information that is read from the reader 7 is recognized by an ID processing unit 11 and is transmitted to the machine operation instruction unit 14 for confirmation of correct exchange. The tool information includes a tool number, a tool length, a tool diameter, and their respective correction values. An operation processing unit 12 transmits instructions in association with an operation of a start button and an operation of a main spindle/feed axis override switch by the operator to the machine operation instruction unit 14. The machine operation instruction unit 14 controls the machine tool with the program and these instructions.

A machine information acquisition unit 13 includes a time series information recording unit 13A and an event information recording unit 13B. The time series information recording unit 13A acquires machine information such as a main spindle load, loads of the respective feed axes, command values of the main spindle and the feed axes, or similar information from the machine operation instruction unit 14 at every any given time. The event information recording unit 13B acquires event information such as a program name, a tool number, and an override value through the operator's operation, or similar information from the machine operation instruction unit 14 at a time of change together with the change time. The time-series data and the event data, which are acquired by the time series information recording unit 13A and event information recording unit 13B, are recorded in a storage unit 16. However, for storage over a long period or a similar case, the time-series data and the event data are moved to and recorded in an external memory 20.

Among the recorded data, event data selected in association with an input instruction of an event extracted by the operator is extracted by an event information extracting unit 17. A machine information clipping unit 18 clips time-series data corresponding to a time at which the extracted event has occurred. A monitor 19 is standardly equipped with the NC system 10 to display the program, a current position of the machine, or similar information. The monitor 19 displays the clipped time-series data in the machine information at the any given extracted event time.

The following describes the clipping of the machine information performed by the machine information clipping unit 18.

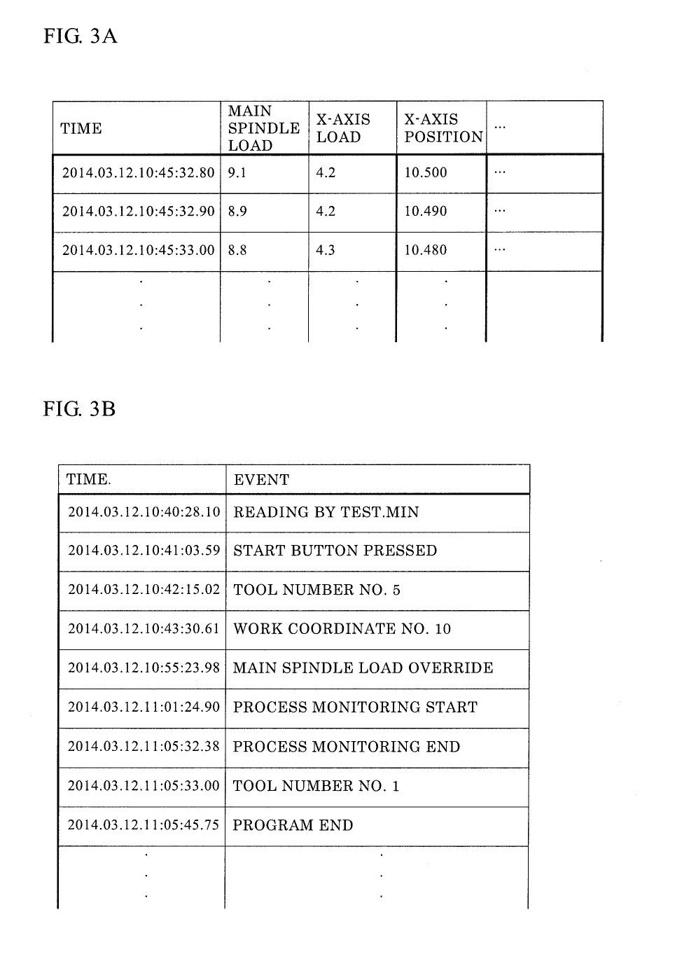

First, the machine information, which is acquired by the machine information machine information acquisition unit 13, includes the time-series data and the event data. The time-series data is related to the machine information at every any given time acquired by the time series information recording unit 13A as shown in FIG. 3A. The event data is related to time when an event such as a tool exchange and start and end of a process monitoring has occurred and their event contents, which are obtained by the event information recording unit 13B as shown in FIG. 3B.

For example, assume the case where a period during which a tool with tool number No. 5 is mounted is instructed to the event information extracting unit 17 to extract the time-series data of FIG. 3A. Then, the time-series data in FIG. 3A is clipped from the time of the tool number No. 5 until the time of the next tool number No. 1 in FIG. 3B.

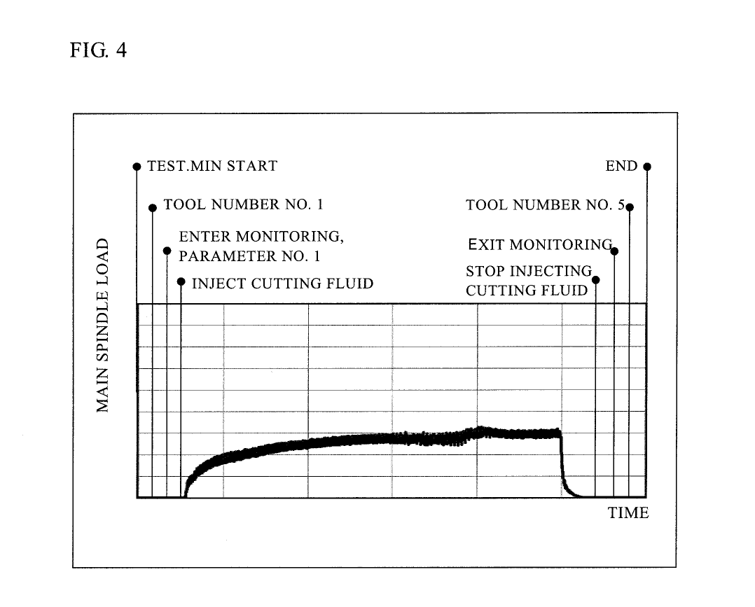

A waveform display window in FIG. 4 shows an example where the machine information clipping unit 18 clips the time-series data of the main spindle load acquired at every any given time by a TEST.MIN execution period. TEST.MIN is a program name selected by the event information extracting unit 17, and the monitor 19 displays the time-series data together with the event data. Here, the tool number is displayed together with the load of the main spindle 2, so that a used tool is grasped. By displaying events of turning on/off a discharge of a cutting fluid, it can be checked that the discharge of the cutting fluid is started before the main spindle load increases by which the execution of cutting can be inferred, and the discharge is stopped at the end of the processing.

To the event information extracting unit 17, event data to be preferentially displayed is specified and the maximum number of display items of event data is specified preliminary, so that main event data such as the tool number may be preferentially displayed in the case where, for example, the waveform display window is made small. In the above manner, the waveform display window shown in FIG. 4 is maintained view-friendly even with the small window.

Thus, the NC system 10 of the machine tool with the configuration includes the time series information recording unit 13A, which acquires the machine information in time series at predetermined timings, the event information recording unit 13B, which records the event information, and output unit (the machine information clipping unit 18 and the monitor 19), which outputs the recorded time-series data and event data together. Therefore, it is ensured to acquire the time-series data of the load or similar information, which allows finding, for example, a time until when the program, the tool, a switch operation of a control panel, the workpiece, and operator information have not changed and a time until when a machine control has been performed. Accordingly, the time-series data with a clear period for handling as a sequence of processes, is acquired over a long period. In view of this, the machine information required for detailed process diagnostics and machine diagnostics can be preferably acquired.

Especially, the output unit includes the machine information clipping unit 18, which makes the time-series data recorded in the time series information recording unit 13A correspond to the time recorded in the event information recording unit 13B to extracts the time-series data. Therefore, a specific piece of time-series data is clipped from the recorded machine information. Accordingly, for example, reference data for process monitoring and large-capacity data recorded at high sampling cycles for detailed analysis are clipped to decrease the capacity, thereby allowing ease of handling. Since data in a required interval is clipped for analysis, analysis efficiency improves. Accordingly, all-time recording of a time series waveform is ensured, which enables recording a processing failure in unanticipated tool and operation, thus allowing the analysis of the processing failure.

The monitor 19 displays the change aspect of the time-series data extracted by the machine information clipping unit 18 and the event data corresponding to the time. Therefore, for example, when the clipped time-series data of the main spindle load during program execution is displayed, the entire processing is reviewed from a higher perspective, leading to the process diagnostics.

Furthermore, the priority order of the event data is preset to the event information recording unit 13B. When the number of the display items of the event data exceeds a preset number, the event information recording unit 13B displays only the event data at high priority orders on the monitor 19. Accordingly, when a period of displayed time-series data is long and therefore the event data is many, especially important event data is preferentially displayed so that the time-series data can be easily reviewed from a higher perspective.

As the machine information, a vibration during processing, the flow rate of the cutting fluid, a counter value of a program-executing block, and similar information are possible, in addition to the load of the rotation shaft, the load of the feed axis, and a position of the feed axis (a command value). At least one of them can be acquired in time series. Among them, by recording the time-series data of the load of the axis and the processing vibration, the process state and the machine state can be determined. Although the program name is identical, if the program is changed and the path is changed, whether or not the paths are identical can be confirmed by the recording of the time-series data of the feed axis. Through the recording of the time-series data of the flow rate of cutting fluid, a failure in a cutting fluid pump and a clogging of a filter can be determined. Furthermore, through the recording of time-series data of a counter value of a program-executing block, a program line in execution can be grasped.

Among the event information, step information can be at least one of a processing step for an interactive system program, the program name, and the sequence number. The tool information can be at least one of the tool number, the tool length correction value, and a tool diameter correction value. The workpiece information can be a workpiece origin or the serial number of the workpiece. Among them, by recording the process step for the interactive system program, a process step for a program created by interactive system programming can be identified. Additionally, as program information, the program name and the sequence number can be recorded. For example, by adding version information to the program name, the used program can be identified. Additionally, with the sequence number, the execution block can be identified. Through recording of the tool number, the tool length correction value, and the tool diameter correction value as the tool information, a tool state can be grasped using a correction value corrected due to tool abrasion. As the workpiece information, the workpiece origin and the serial number of the workpiece can be recorded, thus the axis position on a workpiece coordinate system can be grasped from the origin of the workpiece and the axis position in time series, which is the recorded machine information. The dimensions and measurement value of roughness of the workpiece can be linked to the main spindle load in time series or similar information, which is the machine information, using the serial number.

Furthermore, among the event information, the machine control can be at least one of start and end of program execution, start and end of process monitoring execution, start and end of an axis operation for machine diagnostics, start and end of a fixed cycle operation, and start and end of a discharge of the cutting fluid. Accordingly, the start and end of program execution and the program name can be recorded, thereby ensuring determining a program name actually executed and the execution time. When the period of the start and end of the process monitoring execution can be recorded, for example, a reference waveform is created with the main spindle load during normal processing, and the main spindle load is compared with the reference value at regular time intervals for process monitoring, the time-series data of the main spindle load in the process monitoring interval can be compared with the reference value. The data recorded during the operation of the machine diagnostics and the discharge of the cutting fluid is used to check the normality in such a manner that the maximum value of the time-series data of the feed axis load during the operation of the machine diagnostics is compared with the threshold value, and the time-series data of the flow rate of the cutting fluid during the discharge of the cutting fluid is compared with the threshold value. The data recorded during the fixed cycle operation is used to determine whether or not a motion as assumed has been performed by checking the time-series data of the position of the axis recorded as the machine information.

While in the above-described configuration, the data is clipped using the event data, the data may be additionally clipped between any given times after clipping the data to narrow down the data. A configuration of display to the monitor may also be appropriately changed.

While in the above-described configuration, the monitor in the NC system displays the clipped time-series data as an example, a PC may clip externally stored time-series data over a network and display the time-series data on the monitor of the PC.

Furthermore, information recorded at any given time may employ a microphone mounted to the machine tool or a current of the main spindle/feed axis motor. The any given recording time may also be at intervals of a certain period of time.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. An information acquisition device for a machine tool for acquiring information on the machine tool, the information acquisition device comprising:
a time series information recording unit configured to acquire machine information in time series at a predetermined timing;
an event information recording unit configured to record at least one of: a change content and time at which any one of step information related to a process step, tool information, control panel information related to a control panel of the machine tool, workpiece information, and operator information is changed; and an instruction and time at which the instruction related to a start or an end of machine control execution is issued; and
an output unit configured to output time-series data of the machine information recorded in the time series information recording unit together with event data recorded in the event information recording unit.

2. The information acquisition device according to claim 1, wherein
the output unit includes a machine information clipping unit configured to make the time-series data recorded in the time series information recording unit correspond to the time recorded in the event information recording unit to extract the time-series data.

3. The information acquisition device according to claim 2, wherein
the output unit includes a monitor configured to display a change aspect of the time-series data extracted by the machine information clipping unit and the event data corresponding to the time.

4. The information acquisition device according to claim 3, wherein:
a priority order of the event data is preset to the event information recording unit, and
the output unit is configured to display only the event data at a high-priority in the priority order on the monitor when a count of display items of the event data exceeds a preset count.

5. The information acquisition device according to claim 1, wherein
the machine information includes at least any one of a load of a rotation shaft, a load of a feed axis, a position of the feed axis, a vibration during processing, a flow rate of a cutting fluid, and a counter value of a program-executing block.

6. The information acquisition device according to claim 1, wherein:
the step information includes at least one of a processing step for an interactive system program, a program name, and a sequence number,
the tool information includes at least one of a tool number, a tool length correction value, and a tool diameter correction value,
the control panel information includes a value of an override switch, and
the workpiece information includes one of a workpiece origin and a serial number of the workpiece.

7. The information acquisition device according to claim 1, wherein
the machine control includes at least one of a start and an end of program execution, a start and an end of process monitoring execution, a start and an end of an axis operation for machine diagnostics, a start and an end of a fixed cycle operation, and a start and an end of a discharge of a cutting fluid.
